(19) United States
(12) Patent Application Publication
(10) Pub. No.: US 2008/0252164 A1
(43) Pub. Date: Oct. 16, 2008

(54) Variable speed motor

(76) Inventors: Shi-Bing Huang, Taipei (TW); Xiang-Yi Huang, Taipei (TW)

Correspondence Address: Huang, Shi-Bing, P.O.Box 166-13, Taipei, 115, TW

(21) Appl. No.: 11/785,115

(22) Filed: Apr. 16, 2007

(51) Int. Cl. H02K 47/00; H02K 16/02; H02K 21/12; H02K 1/12

(52) U.S. Cl. 310/112; 310/254; 310/156.32; 310/114

(57) ABSTRACT

Shift gears of a variable speed motor is no longer needed for a set of gears, but multiple layers disks with magnets fit over an axle rotated by a multiple layers annular opening of a housing, where winding coils wound along inside each annulus seperately. When electrifying each winding coils on each annulus, each corresponding disk can rotate the axle at a fixed ratio to output an extreme high speed or a high torque at low or moderate speed. Such disks and annuli are arranged according to their decrement diameters from the opening to a top of the housing; thereby, each disk is corresponding to each annulus with winding coils in one-to-one relationship. However, magnets disposed to a perimeter of each disk, which is made from magnetic insulation material, such as aluminum alloys, to avoid from interference among each disk.

### FIELD OF THE INVENTION

The present invention is related to a variable speed motor, particularly to a motor with varying rotation rate to accommodate to timely speeding up to an extreme speed or lowering speed with torque control.

### DESCRIPTION OF THE PRIOR ARTS

Rotation rate of an axle of motor is almost adjusted within a constant power operation range. Such a motor can be used as a stable power source to a vehicle (such as a car, a motor bike, low speed electric bicycle) or a machine tool (such as a lathe, a driller, a miller); in addition, a gearbox or a belt device with stepless transmission is in usual provided thereto for an efficient performance.

Person skilled in the art have provided variable speed motors as disclosed in TW 318635 entitled “co-axial gear reducer motor” to Han-Lin Kou on Oct. 21, 1997, Kou mainly taught that an output shaft installed within a hollowed input shaft, which has a gear meshed with a gear of an intermediate shaft, which in turn has a pinion meshed with a gear of the output shaft. Thereby, the output shaft and the input shaft are in a concentric arrangement, by which a set of three gears and one pinion are combined to reduce speed. Motor revolution speed can be altered to maintain stability for high or low frequency use, to reduce speed at a fixed ratio is retained by the set of gears and pinion, a useful energy delivered by the motor can be expected therefrom.

Although such a conventional motor must be provided with gear lubricant to grease the gears and pinion, but noises still could not be eliminated from the set of gears during rotation speed changing in a hurry. Even a belt device with stepless transmission has drawbacks such as the belt is loosen, broken or other components may be worn out quickly.

Said co-axial gear reducer motor has some drawbacks as follows:
1. Only one motor is to vary the rotation rate of output shaft at high or low frequency current, but not to provide a smooth torque control either from low to high speed or from high to low speed.
2. Reducing speed of the set of gears at a fixed ratio is restricted to a smaller scope caused by a single motor starts directly to vary rotation rate of the output shaft within a small scope.
3. Rotation rate of the output shaft is started in connection with the single motor directly, when slowing the output shaft is to hold down the motor with a degraded torque control performance.

### SUMMARY OF THE INVENTION

Accordingly, the present invention is aimed to provide a variable speed motor, which is easy to drive, with an output shaft can “shift gears” smoothly to speed up with a ratio of increasing speed. Even the variable speed motor to vary speed does not depend on the gear set, but depends on disks at different diameters therein.

Such a variable speed motor 10 comprising: a housing 1 having a chamber 11 formed with a concentric interior stepped opening, which is shaped by a plurality of annuli, each stepped annulus is formed with a decrement diameter from the opening to a top of the chamber 11; a bearing 12 disposed at a center of the top of the chamber 11 for passing through an axle 3;

coils 2, winding coils disposed around the concentric interior stepped opening of the chamber 11;

The axle 3 disposed to a center of the housing 1, one end of the axle passing through the bearing 12 of the housing 1;

A plurality of rolling disks 4 made of magnetic insulation material, such as aluminum alloys, magnets 42 disposed around a perimeter of each disk 4 shaped with decrement diameters from the opening to the top of the chamber 11 and stacked as a concentric stepped cone with a hollowed center, each disk 4 is equipped with a one-way bearing 41 at the hollowed-center to fit over the axle 3, each disk 4 is relative to each annulus of the chamber 11, whereby the coils 2 wound along each annulus separately is corresponding to the magnets 42 of each disk 4, to electrify each winding coils 2 of each annulus can rotate each corresponding disk 4 respectively, in turn, the axle 3 is rotated by the rotated disk 4; and

A cover 5 is used to seal an opening of the chamber 11, a bearing 51 disposed at a center where the axle 3 is passed therethrough.

A variable speed motor 10 as mentioned above, wherein a closed end of the housing 1 sealed by a cover, an axle hole formed at a center of the cover is disposed with a bearing 12.

### BRIEF DESCRIPTION OF THE DRAWINGS

FIG. 1: shows an exploded view of the variable speed motor of the invention;

FIG. 2: shows an assembled view of the variable speed motor of the invention; and

FIG. 3: shows a cross section view of the variable speed motor of the invention.

### DETAILED DESCRIPTION OF THE PREFERRED EMBODIMENTS

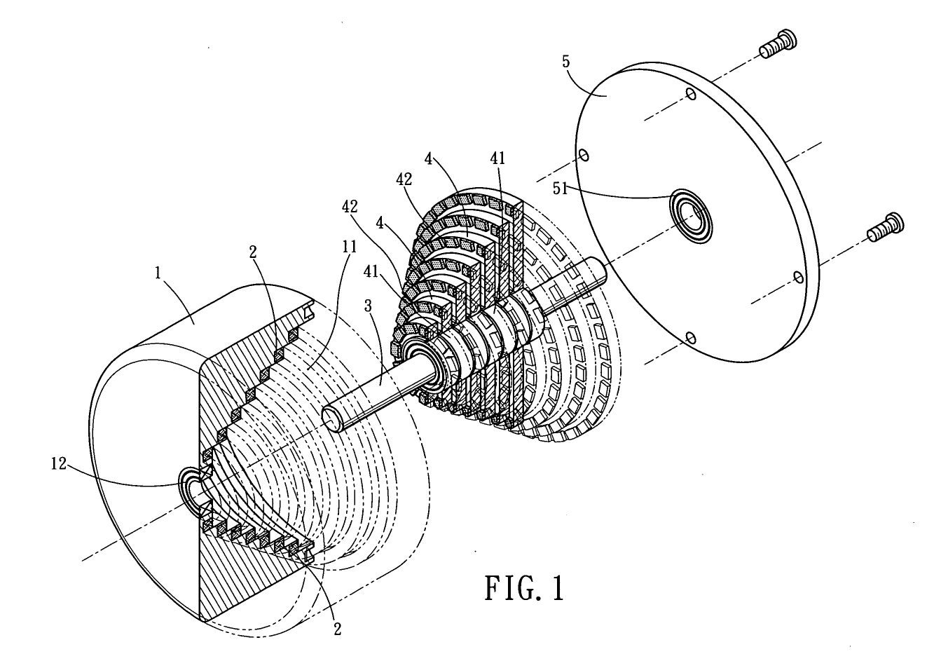

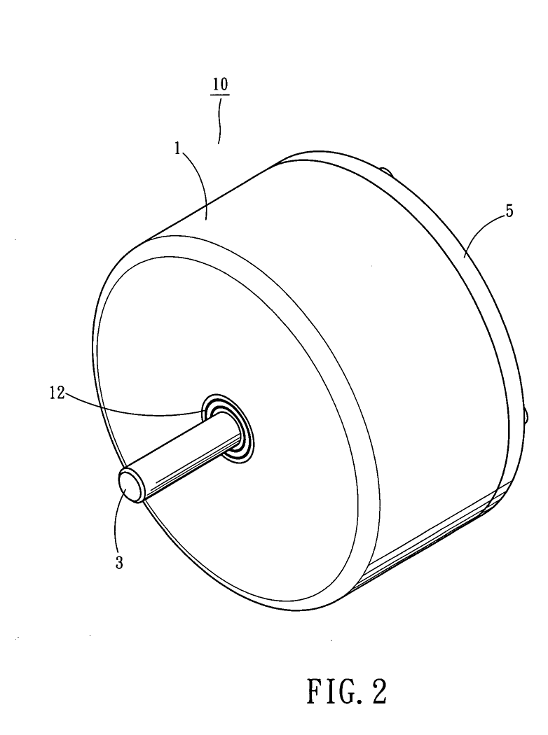

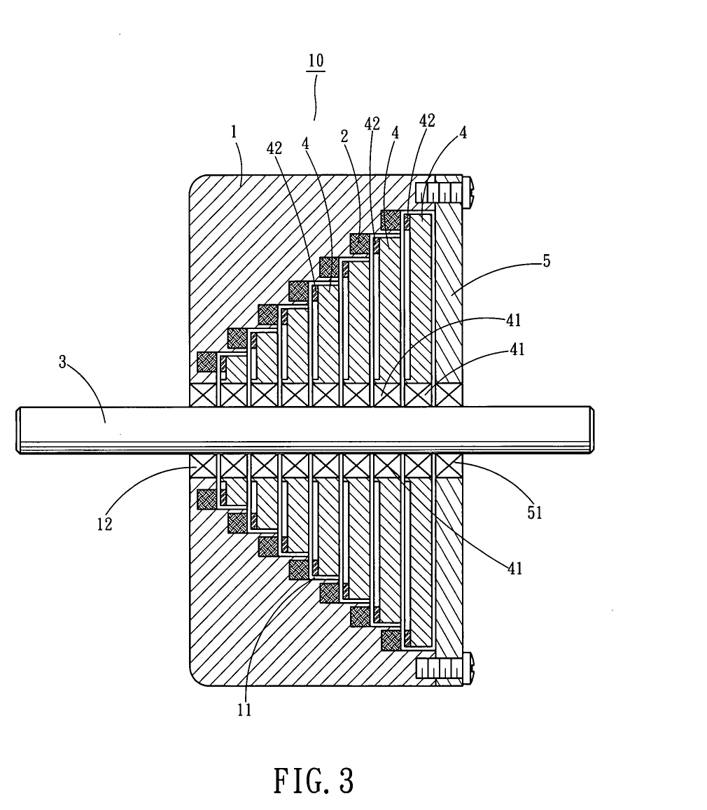

FIG. 1 shows an exploded view of the variable speed motor of the invention. The variable speed motor 10 includes a housing 1, coils 2, an axle 3, disks 4, and a cover 5. After assembly, the assembled view of the variable speed motor of the invention is illustrated as shown in FIG. 2. A cross section view of the assembled variable speed motor is illustrated as shown in FIG. 3.

Inside the housing 1, a chamber 11 is formed with a concentric interior stepped opening, which is shaped by a plurality of annuli, each stepped annulus is formed with a decrement diameter from the opening to a top of the chamber 11. A bearing 12 is disposed at a center of the chamber 11 for passing through the axle 3. The winding coils 2 are wound inside the chamber 11 along each stepped annulus separately. A plurality of disks 4 are relative to the plurality of annuli in one-to-one relationship, even numbers or layers of the disks 4 are identical to the annuli with winding coils 2 has. But each disk 4 has magnets 42 disposed around its perimeter, although each disk 4 has different diameter. The disks 4 are stacked together one by one in order, in addition, the disks 4 are stacked from the opening to the top of the housing are arranged according to their decrement diameters to form a concentric stepped cone. But the stepped cone is hollowed out at the center, which is further equipped with one-way bearings to each disk 4 to fit over the axle 3. Each disk 4 with magnets 42 disposed around the perimeter is corresponding to each annulus with winding coils 2 wound along inside the annulus. Selectively electrifying one winding coils 2 only wounded along inside one annulus can rotate one corresponding disk 4 so that the axle 3 is also rotated with variable speeds performance. (Where number of “shift gears” can be determined in accordance with the layers of chamber 11) When electrify a small disk 4 to rotate the axle, it will output a higher rotation rate but a smaller torque, while electrify a large disk 4 to rotate the axle, it will output a lower rotation rate but a larger torque.

Moreover, the disks 4 are made from magnetic insulation materials, such as aluminum alloys, to avoid from magnets 42 and disk 4 of different layers are interfered with each other's magnetic field. While the magnets 42 can be added to the disk 4 by ways of screwing, adhesive, etc., that are familiar to the persons skilled in the prior arts. Further, the cover 5 is used to seal the opening of the housing 1, which is also disposed with a bearing 51 at a center of the top where the axle 3 is passing therethrough.

The other end of the housing 1 is closed; one end of the housing is an opening. However, in practice, the housing 1 can be realized by such a configuration as following: both ends of the housing 1 are openings (not shown); the housing can be shaped like a cylinder, one end can be screwed to the cover 5 of the housing 1 by a bolt or screw. While on the other end the cover is secured to the cover 5 by screwing.

It is to facilitate the persons skilled in the art to assemble the variable speed motor of the invention.

As discussed above, the variable speed motor 10 can be operated manually or by computerization to output variable speed under control.

### ADVANTAGES OF EMBODIMENTS OF THE INVENTION

Disks 4 with decrement diameters can be rotated to bring about the axle 3 to rotate simultaneously, either speeding up the axle to an extreme high speed or outputting higher torque at lower to moderate speed. Further the motor using a speed reducer or connected to a transmission shaft of an electric vehicle or a machine tool must be adjusted with its working speed (such as a lathe, a driller, a miller) in connection with related control circuits, let the vehicle or machine tool have multiple variable speeds instead of conventional gearbox or belt device.

Variable speed motor vary rotation rate of the output shaft can deliver the required energy by rotating disks 4 at different diameters to bring about the axle 3 in rotation under control. Output shaft when varying speed, is under the circumstance the motor can “shift gears” smoothly—even the variable speed motor to vary speed does not depend on the gear set—but depends on disks at different diameters therein. Thereby, to vary speed by the motor directly can achieve a more feasible ratio for varying speed. Furthermore, to vary speed by the motor directly, the motor can be started easily because it output higher torque at lower or moderate speed under control.

What is claim claimed:

1. A variable speed motor (10) comprising: a housing (1) having a chamber (11) formed with a concentric interior stepped opening, which is shaped by a plurality of annuli, each stepped annulus is formed with a decrement diameter from the opening to a top of the chamber (11); a bearing (12) disposed at a center of the top of the chamber (11) for passing through an axle (3);
coils (2), winding coils disposed around the concentric interior stepped opening of the chamber (11);
the axle (3) disposed to a center of the housing (1), one end of the axle passing through the bearing (12) of the housing (1);
a plurality of rolling disks (4) made of magnetic insulation material, such as aluminum alloys, magnets (42) disposed around a perimeter of each disk (4) shaped with decrement diameters from the opening to the top of the chamber (11) and stacked as a concentric stepped cone with a hollowed center, each disk (4) is equipped with a one-way bearing (41) at the hollowed-center to fit over the axle (3), each disk (4) is relative to each annulus of the chamber (11), whereby the coils (2) wound along each annulus separately is corresponding to the magnets (42) of each disk (4), to electrify each winding coils (2) within each annulus can rotate each corresponding disk (4) respectively, in turn, the axle (3) is rotated by the rotated disk (4); and
a cover (5) is used to seal an opening of the chamber (11), a bearing (51) disposed at a center where the axle (3) is passed therethrough.

2. A variable speed motor (10) according to claim 1, wherein a closed end of the housing (1) sealed by a cover, an axle hole formed at a center of the cover is disposed with a bearing (12).
